(19) United States
(12) Patent Application Publication
(10) Pub. No.: US 2014/0063427 A1
(43) Pub. Date: Mar. 6, 2014

(54) RESIN COMPOSITION FOR THERMAL RADIATION BOARD AND THERMAL RADIATION BOARD COMPRISING THE SAME

(71) Applicant: SAMSUNG ELECTRO-MECHANICS CO., LTD., Suwon (KR)

(72) Inventors: Jeong Kyu LEE, Suwon (KR); Seong Hyun Yoo, Suwon (KR); Hyun Jun Lee, Suwon (KR); Jin Seok Moon, Suwon (KR); Keun Yong Lee, Suwon (KR)

(73) Assignee: SAMSUNG ELECTRO-MECHANICS CO., LTD., Suwon (KR)

(21) Appl. No.: 13/683,037

(22) Filed: Nov. 21, 2012

(30) Foreign Application Priority Data
Sep. 6, 2012 (KR) 10-2012-0099005

(51) Int. Cl. C08K 3/00; C08L 63/00; G02F 1/1337

(52) U.S. Cl. CPC C08K 3/0075; G02F 1/1337; C08L 63/00
USPC 349/138; 523/466; 523/457; 523/458; 523/459

(57) ABSTRACT

There is provided a resin composition for a thermal radiation board including: 20 wt % to 50 wt % of a liquid crystal oligomer represented by particular Chemical Formulas; 10 wt % to 40 wt % of an epoxy resin; and 10 wt % to 40 wt % of an inorganic filter.

### CROSS-REFERENCE TO RELATED APPLICATIONS

This application claims the priority of Korean Patent Application No. 10-2012-0099005 filed on Sep. 6, 2012, in the Korean Intellectual Property Office, the disclosure of which is incorporated herein by reference.

### BACKGROUND OF THE INVENTION

1. Field of the Invention

The present invention relates to a resin composition for a thermal radiation board having excellent thermal characteristics, and a thermal radiation board including the same.

2. Description of the Related Art

Recently, a range of electronic products such as computers, semiconductors, displays, communications devices, and the like, have been developed, electrical, thermal, and the mechanical stability of boards applied to electronic products has been recognized as an important element in the stability thereof.

In particular, products utilizing light emitting diodes (LEDs) have formed an extensive market segment, covering boards, displays, automobiles, traffic lights, backlights, and general illumination devices, and various fields of application thereof have continuously grown. LEDs are required to have properties such as high luminous energy, high efficiency, and a large area, and to this end, an LED package is required to have a high level of heat dissipation, while being formed to be lighter, thinner, shorter, and smaller than related art devices, as well as having reliability, and the like, secured therein.

Conventionally, the application of a ceramic-based material to an LED package has been developed, but material costs of ceramic substrates may be relatively high, and when a board for mounting a plurality of LEDs thereon is fabricated, cracks may be generated therein due to an increase in the size of the board.

In addition, since coefficients of thermal expansion between a ceramic substrate and a molding resin are different, an interface therebetween may be delaminated during high temperature driving, causing a problem in terms of reliability. Thus, the necessity of a resin composition for an insulating layer having excellent heat dissipation characteristics and reliability has grown.

### PRIOR ART DOCUMENT

(Patent document 1) Korean Patent Laid Open Publication No. 10-2011-0108782

### SUMMARY OF THE INVENTION

An aspect of the present invention provides a resin composition for a thermal radiation board having excellent thermal characteristics and a thermal radiation board including the same.

According to an aspect of the present invention, there is provided a resin composition for a thermal radiation board, including: 20 wt % to 50 wt % of a liquid crystal oligomer including a structural unit of Chemical Formula 1 shown below and a structural unit of Chemical Formula 2 shown below and including a functional group of Chemical Formula E shown below on least one end thereof; 10 wt % to 40 wt % of an epoxy resin; and 10 wt % to 40 wt % of an inorganic filter.

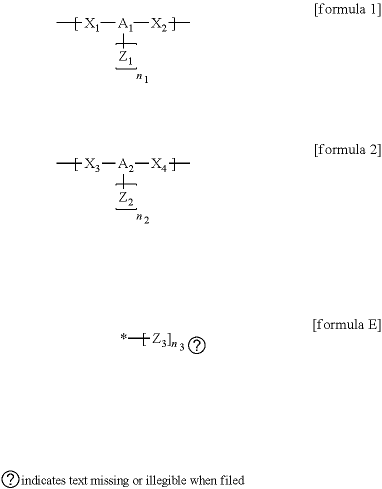

In Chemical Formulas 1 and 2 and Chemical Formula E shown above, X₁ to X₄ are the same or different and C(═O)O, O, C(═O)NR, NR′, or CO (here, R and R′ are the same or different, are hydrogen, a substituted or unsubstituted C1 to C20 alkyl group, or a substituted or unsubstituted C6 to C30 aryl group), Z₁ to Z₃ are independently a hydroxyl group, a substituted or unsubstituted C3 to C30 cycloaliphatic group, or a substituted or unsubstituted C3 to C30 heteroatom-containing cycloaliphatic group,

n₁ to n₃ may be independently an integer of 0 to 3 and n₁+n₂+n₃ may be 1 or greater, and

A₁ in Chemical Formula 1 shown above is one among functional groups represented by Chemical Formula 4-1 to Chemical Formula 4-7 shown below.

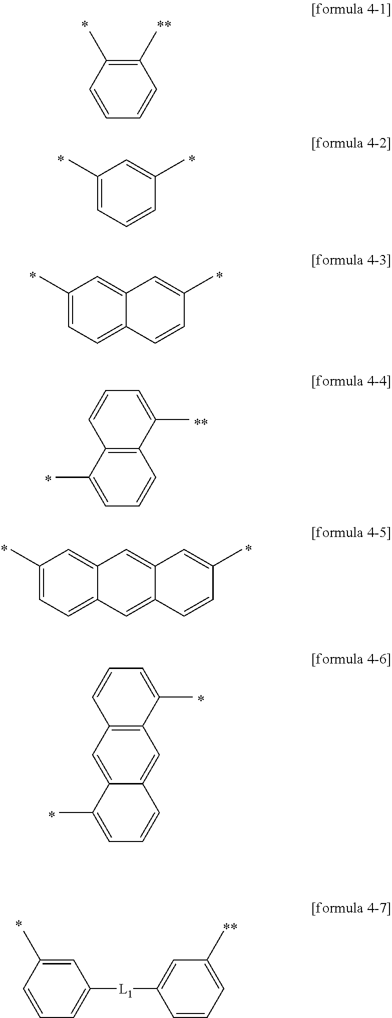

In Chemical Formula 4-7 shown above, L₁ is a bivalent organic functional group, in Chemical Formulas 4-1 to Chemical Formula 4-7 shown above, at least one hydrogen atom of the respective aromatic rings may be substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above), and

in Chemical Formula 2 shown above, A₂ is a C2 to C20 alkylene group having one among functional groups represented by Chemical Formula 5-1 to Chemical Formula 5-6 shown below or a functional group of Chemical Formula 6 shown below.

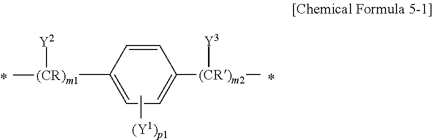

In Chemical Formula 5-1 shown above, Y¹ to Y³ are the same or different, are hydrogen, a C1 to C10 alkyl group, or a functional group of Chemical Formula 6 shown below, and at least one of Y¹ to Y³ is a functional group of Chemical Formula 6 shown below, p1 is an integer of 0 to 4, m1 and m2 are the same or different and are integers of 0 to 3, p1, m1, and m2 are not 0 simultaneously, and R and R′ are hydrogen or a C1 to C10 alkyl group.

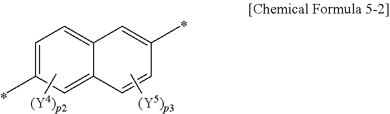

In Chemical Formula 5-2 shown above, Y⁴ and Y⁵ are the same or different, and are hydrogen, a C1 to C10 alkyl group, or a functional group of Chemical Formula 6 shown below, at least one of Y⁴ and Y⁵ is a functional group of Chemical Formula 6 shown below, and p2 and p3 are integers of 0 to 3 and not 0 simultaneously.

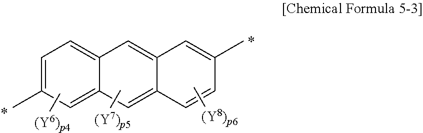

In Chemical Formula 5-3 shown above, Y⁶ to Y⁸ are the same or different, and are hydrogen, a C1 to C10 alkyl group or a functional group of Chemical Formula 6 shown below, at least one of Y⁶ to Y⁸ is a functional group of Chemical Formula 6 shown below, p4 to p6 are integers of 0 to 3, p5 is an integer of 0 to 2, and p4, p5, and p6 are not 0 simultaneously.

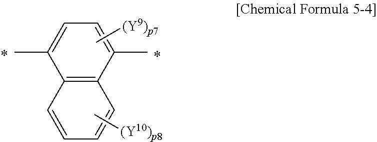

In Chemical Formula 5-4 shown above, Y⁹ and Y¹⁰ are the same or different, and are hydrogen, a C1 to C10 alkyl group or a functional group of Chemical Formula 6 shown below, at least one of Y⁹ and Y¹⁰ is a functional group of Chemical Formula 6 shown below, and p7 and p8 are integers of 0 to 2 and not 0 simultaneously.

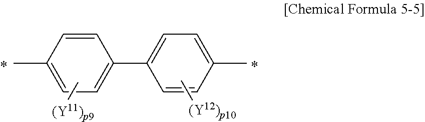

In Chemical Formula 5-5 shown above, Y¹¹ and Y¹² are the same or different, and are hydrogen, a C1 to C10 alkyl group or a functional group of Chemical Formula 6 shown below, at least one of Y¹¹ and Y¹² is a functional group of Chemical Formula 6 shown below, and p9 and p10 are integers of 0 to 4 and not 0 simultaneously.

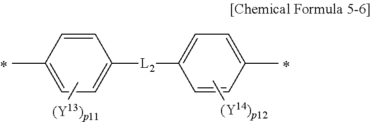

In Chemical Formula 5-6 shown above, Y¹³ and Y¹⁴ are the same or different, and are hydrogen, a C1 to C10 alkyl group or a functional group of Chemical Formula 6 shown below, at least one of Y¹³ and Y¹⁴ is a functional group of Chemical Formula 6 shown below, and p11 and p12 are integers of 0 to 4, L₂ is an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown below, or a bivalent organic functional group of Chemical Formula 7-1 to Chemical Formula 7-3 shown below, and when L₂ is not substituted with the functional group of Chemical Formula 6 shown below, p11 and p12 are not all 0,

in Chemical Formula 5-1 to Chemical Formula 5-6 shown above, at least one hydrogen atom of the respective aromatic rings may be substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above).

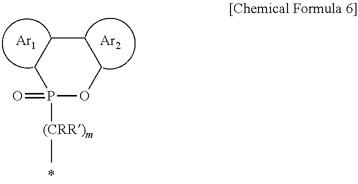

In Chemical Formula 6 shown above, Ar₁ and Ar₂ are substituted or unsubstituted C4 to C30 aromatic ring groups, R and R′ are the same or different, are hydrogen, a C1 to C20 alkyl group or a C6 to C30 aryl group, and m is an integer of 0 to 3.

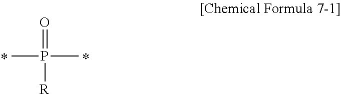

In Chemical Formula 7-1 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group.

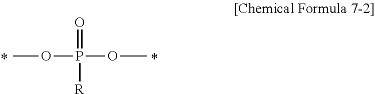

In Chemical Formula 7-2 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group.

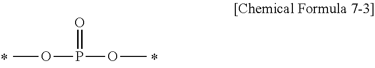

A number average molecular weight of the liquid crystal oligomer may be 500 to 10,000 g/mol.

L₁ in Chemical Formula 4-7 shown above may be an ether group, a sulfide group, a ketone group, sulfoxide, a sulfone group, an azo group, a cyanide group, a substituted or unsubstituted C1 to C20 alkylene group, a substituted or unsubstituted C2 to C20 alkenyl group, or a substituted or unsubstituted C6 to C30 arylene group.

L₂ in Chemical Formula 5-6 shown above may be an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown above, or a bivalent organic functional group of Chemical Formula 7-1 to Chemical Formula 7-3 shown above.

Chemical Formula 6 may be represented by Chemical Formula 11 shown below.

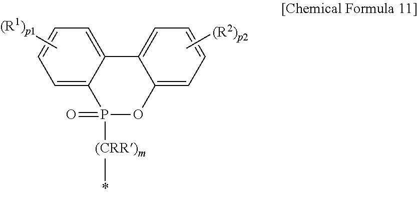

In Chemical Formula 11 shown above, R¹ and R² are the same or different, and are hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above), p1 and p2 are integers of 0 to 4, R and R′ are the same or different, are hydrogen, C1 to C20 alkyl groups, or C6 to C30 aryl groups, and m is an integer of 0 to 3.

The liquid oligomer may be represented by Chemical Formula 12 shown below.

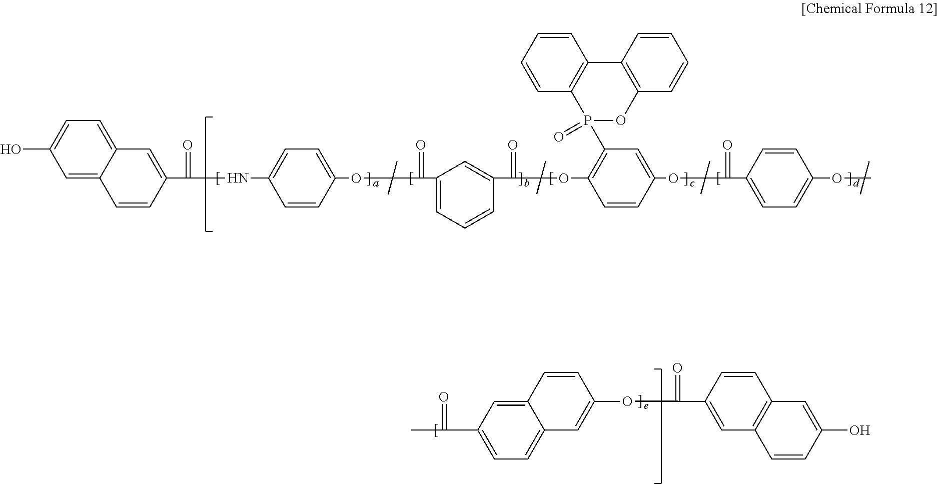

In Chemical Formula 12 shown above, a, b, c, d, and e indicate a mole ratio of a structural unit, which may be determined within a number average molecular weight of the liquid oligomer.

The number average molecular weight of the liquid oligomer represented in Chemical Formula 12 shown above may range from 2000 to 5000 g/mol.

The epoxy resin may be a phenol-based glycidyl ether epoxy resin such as a phenol novolak epoxy resin, a cresol novolak epoxy resin, naphtol-modified novolak epoxy resin, a bisphenol A type epoxy resin, a bisphenol F type epoxy resin, a biphenyl epoxy resin, triphenyl epoxy resin, and the like; a dicyclopentadiene epoxy resin having a dicyclopentadiene frame; a naphthalene epoxy having a naphthalene frame; a dihydroxybenzopyran epoxy resin; a glycidylamine epoxy resin using a polyamine such as diaminophenylmethane, or the like, as a raw material; a triphenolmethane epoxy resin; a tetraphenylethane epoxy resin; or a mixture thereof.

The inorganic filler may be one or more of natural silica, fused silica, amorphous silica, hollow silica, aluminum hydroxide, beohmite, magnesium hydroxide, molybdenum oxide, zinc molybdate, zinc borate, zincstannate, aluminum borate, potassium titanate, magnesium sulfate, silicon carbide, zinc oxide, silicon nitride, silicon oxide, aluminum titanate, barium titanate, barium strontium titanate, aluminum oxide, alumina, clay, kaolin, talc, calcinated clay, calcinated kaolin, calcinated talc, mica, and short glass fiber.

The inorganic filler may be obtained by mixing two or more of a spherical inorganic filler, a flake-type inorganic filler, and a whisker-type inorganic filler.

An insulating resin composition for a thermal radiation board according to an embodiment of the present invention may include a hardening catalyst.

The hardening catalyst may be, for example, 2-methylimidazole, 2-phenylimidazole, 2-phenyl-4-phenyl imidazole, bis(2-ethyl-4-methylimidazole), 2-phenyl-4-methyl-5-hydroxymethylimidazole, 2-phenyl-4,5-dihydroxymethylimidazole, trizine added imidazole, anhydride methyl nadic acid, dicyandiamide, phthalic anhydride, tetrahydrophthalic anhydride, methylbutyltetrahydro phthalic anhydride, hexahydro phthalic anhydride, methylhydrophthalic anhydride, trimethylic acid anhydride, pyromethalic acid anhydride, or benzophenonetetracarboxylic acid anhydride, and the like, and these may be mixed to be used. However, the present invention is not limited thereto.

According to another aspect of the present invention, there is provided a sheet-type film including 20 to 50 wt % of a liquid crystal oligomer including a structural unit of Chemical Formula 1 shown above and a structural unit of Chemical Formula 2 shown above, and including a functional group of Chemical Formula E shown above in at least one end thereof; 10 to 40 wt % of an epoxy resin; and 10 to 40 wt % of an inorganic filler.

According to another aspect of the present invention, there is provided a thermal radiation board including: a metal layer; an insulating layer formed on the metal layer; and a circuit pattern formed on the insulating layer, wherein the insulating layer is made of a resin composition including 20 to 50 wt % of a liquid crystal oligomer including a structural unit of Chemical Formula 1 shown below and a structural unit of Chemical Formula 2 shown below, and including a functional group of Chemical Formula E shown below in at least one end thereof; 10 to 40 wt % of an epoxy resin; and 10 to 40 wt % of an inorganic filler.

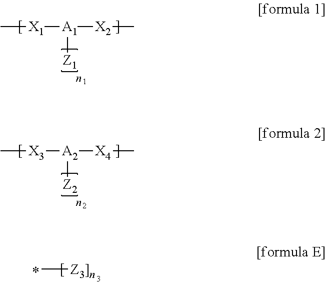

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a thermal radiation board according to an embodiment of the present invention.

### DETAILED DESCRIPTION OF THE PREFERRED EMBODIMENT

Embodiments of the present invention will now be described in detail with reference to the accompanying drawings.

The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

The same reference numerals will be used for parts having similar functions and operations throughout the drawings.

Unless explicitly described to the contrary, the word “comprise” and variations such as “comprises” or “comprising,” will be understood to imply the inclusion of stated elements but not the exclusion of any other elements.

Unless otherwise mentioned, ‘substitution’ refers to substituting a hydrogen atom among a compound or a functional group with a substituent of halogen (fluorine (F), chlorine (Cl), bromine (Br), or iodine (I)), a hydroxyl group, an alcoxy group, a nitro group, a cyano group, an amino group, an azido group, an amidino group, a hydrazine group, a hydrozono group, a carbonyl group, a carbamyl group, a thiol group, an ester group, a carboxyl group or salt thereof, a sulfonic acid group or salt thereof, a phosphoric acid or salt thereof, a C1 to C20 alkyl group, a C2 to C16 alkynyl group, a C6 to C20 aryl group, a C7 to C13 arylalkyl group, a C1 to C4 oxyalkyl group, a C1 to C20 heteroalkyl group, a C3 to C20 heteroarylalkyl group, a C3 to C20 cycloalkyl group, a C3 to C15 cycloalkenyl group, a C6 to C15 cycloalkynyl group, a heterocycloalkyl group, or a combination thereof.

Unless otherwise mentioned in the present disclosure, ‘hetero’ refers to the presence of one to three hetero atoms of nitrogen (N), oxygen (O), serine (S), silicon (Si), or phosphorous (P) within a ring.

Unless otherwise mentioned in the present disclosure, ‘cycloaliphatic group’ refers to a C3 to C30 cycloalkyl group, a C3 to C30 cycloalkenyl group, a C3 to C30 cycloalkynyl group, a C3 to C30 heterocycloalkyl group, a C3 to C30 heterocycloalkenyl group, a C3 to C30 heterocycloalkynyl group, or the like.

Unless otherwise mentioned in the present disclosure, an ‘aromatic ring group’ refers to a functional group having a ring structure in which unsaturated bonds, unshared electron pairs (or lone pairs), and the like, are mixed, wherein electrons have a delocalization or resonance structure. The aromatic ring group refers to a C6 to C30 aryl group, a C2 to C30 heteroaryl group, and a C2 to C30 heterocycloalkenyl group.

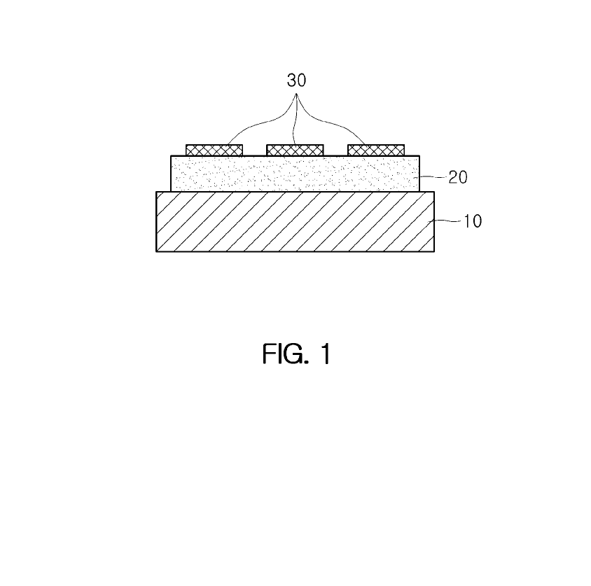

Referring to FIG. 1, a thermal radiation board according to an embodiment of the present invention may include a metal layer 10, an insulating layer 20, and a circuit pattern 30 formed on the insulating layer 20. In the present embodiment, a thermal radiation board having a single layer structure is illustrated, but the present invention is not limited thereto and the thermal radiation board may be configured as a uni-layer wiring board or a multilayer wiring board including two or more layers according to the number of laminated insulating layers 20 and the formed circuit pattern 30, and here, the circuit pattern 30 may be formed on one surface or both surfaces of the insulating layer 20.

The metal layer 10 serves to dissipate heat and may include a metal such as aluminum (Al), copper (Cu), or the like, but the present invention is not limited thereto.

The insulating layer 20 of the thermal radiation board may be made of an insulating resin composition.

In other words, the insulating layer 20 may be made of a resin composition for a thermal radiation board according to an embodiment of the present invention described in detail hereinafter.

Here, the insulating layer 20 may be made of prepreg obtained by impregnating a resin composition for a thermal radiation board according to an embodiment of the present invention with a strengthening agent.

When a board is made of the resin composition according to the present embodiment as mentioned above, the board can be fabricated to have electrical, thermal, and mechanical stability as well as excellent heat dissipation characteristics (or thermal radiation characteristics), although it has a smaller weight, is thinner, and smaller than those of the related art.

Constituent components of the resin composition for a thermal radiation board and characteristics thereof according to an embodiment of the present invention will be described in detail.

A resin composition according to an embodiment of the present invention may include (A) a liquid crystal oligomer (LCO), (B) an epoxy resin, and (C) an inorganic filler, and may further include (D) a hardening catalyst, a solvent, and the like.

(A) Liquid Crystal Oligomer (LCO)

An LCO included in a resin composition according to the present embodiment may include a structural unit of Chemical Formula 1 shown below and a structural unit of Chemical Formula 2 shown below and include a functional group of Chemical Formula E shown below on least one end thereof.

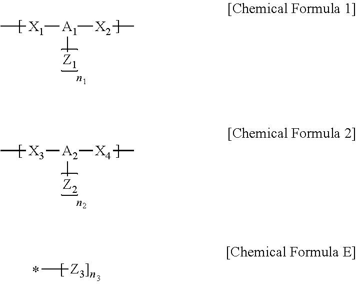

In Chemical Formulas 1 and 2 and Chemical Formula E shown above, X₁ to X₄ may be the same or different and may be C(═O)O, O, C(═O)NR, NR′, or CO (here, R and R′ are the same or different, are hydrogen, a substituted or unsubstituted C1 to C20 alkyl group, or a substituted or unsubstituted C6 to C30 aryl group).

Z₁ to Z₃ may be independently a hydroxyl group, a substituted or unsubstituted C3 to C30 cycloaliphatic group, or a substituted or unsubstituted C3 to C30 heteroatom-containing cycloaliphatic group.

And, n₁ to n₃ may be independently an integer of 0 to 3, and n₁+n₂+n₃ may be 1 or greater.

A₁ in Chemical Formula 1 shown above may be one among functional groups represented by Chemical Formula 4-1 to Chemical Formula 4-7 shown below.

In A₁, both couplers of an aromatic ring bonded to a main chain may be placed in an ortho or meta position.

An aromatic structural unit having such a kink structure may be repeatedly introduced to the main chain of the LCO.

Namely, linearity of the main chain of the LCO is reduced according to the introduction of the kink structure, and thus, interaction between main chains and crystallinity may be reduced to enhance solubility with respect to a solvent.

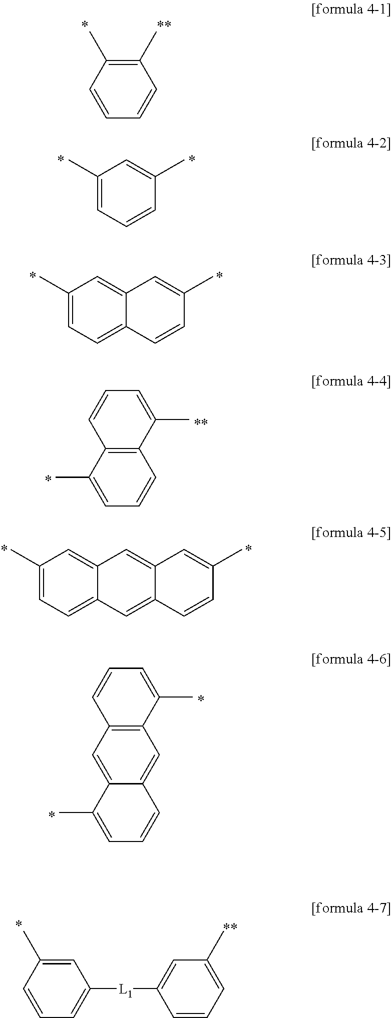

In Chemical Formula 4-7 shown above, L₁ is a bivalent organic functional group, in Chemical Formulas 4-1 to Chemical Formula 4-7 shown above, at least one hydrogen atom of the respective aromatic rings may be substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above).

In Chemical Formula 2 shown above, A₂ is a C2 to C20 alkylene group having one among functional groups represented by Chemical Formula 5-1 to Chemical Formula 5-6 shown below or a functional group of Chemical Formula 6 shown below.

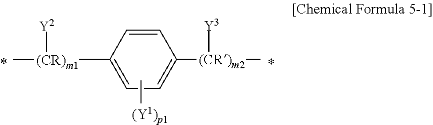

In Chemical Formula 5-1 shown above, Y¹ to Y³ may be the same or different, are hydrogen, a C1 to C10 alkyl group, or a functional group of Chemical Formula 6 shown below. At least one of Y¹ to Y³ may be a functional group of Chemical Formula 6 shown below, p1 may be an integer of 0 to 4, m1 and m2 may be the same or different and are integers of 0.to 3, p1, m1, and m2 may not be 0 simultaneously, and R and R′ may be hydrogen or a C1 to C10 alkyl group.

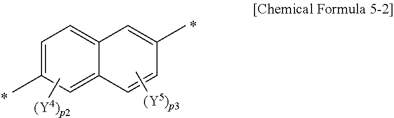

In Chemical Formula 5-2 shown above, Y⁴ and Y⁵ may be the same or different, and may be hydrogen, a C1 to C10 alkyl group, or a functional group of Chemical Formula 6 shown below, at least one of Y⁴ and Y⁵ is a functional group of Chemical Formula 6 shown below. And, p2 and p3 may be integers of 0 to 3 and not 0 simultaneously.

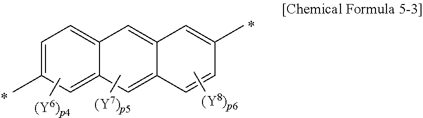

In Chemical Formula 5-3 shown above, Y⁶ to Y⁸ may be the same or different and may be hydrogen, a C1 to C10 alkyl group, or a functional group of Chemical Formula 6 shown below, at least one of Y⁶ to Y⁸ is a functional group of Chemical Formula 6 shown below. And, p4 to p6 may be integers of 0 to 3, p5 is an integer of 0 to 2. And, p4, p5, and p6 are not 0 simultaneously.

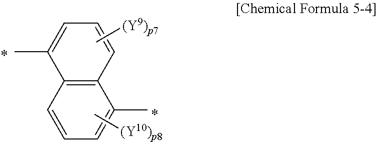

In Chemical Formula 5-4 shown above, Y⁹ and Y¹⁰ may be the same or different and may be hydrogen, a C1 to C10 alkyl group, or a functional group of Chemical Formula 6 shown below, at least one of Y⁹ and Y¹⁰ is a functional group of Chemical Formula 6 shown below. An, p7 and p8 may be integers of 0 to 2 and not 0 simultaneously.

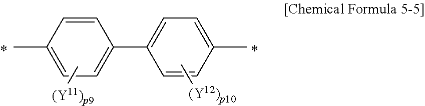

In Chemical Formula 5-5 shown above, Y¹¹ and Y¹² may be the same or different and may be hydrogen, a C1 to C10 alkyl group, or a functional group of Chemical Formula 6 shown below, at least one of Y¹¹ and Y¹² may be a functional group of Chemical Formula 6 shown below. And, p9 and p10 may be integers of 0 to 4 and not 0 simultaneously.

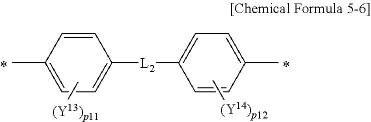

In Chemical Formula 5-6 shown above, Y¹³ and Y¹⁴ may be the same or different and may be hydrogen, a C1 to C10 alkyl group, or a functional group of Chemical Formula 6 shown below, at least one of Y¹³ and Y¹⁴ may be a functional group of Chemical Formula 6 shown below, and p11 and p12 are integers of 0 to 4, L₂ is an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown below, or a bivalent organic functional group of Chemical Formula 7-1 to Chemical Formula 7-3 shown below, and when L₂ is not substituted with the functional group of Chemical Formula 6, p11 and p12 may not be all 0.

In Chemical Formula 5-1 to Chemical Formula 5-6 shown above, at least one hydrogen atom of the respective aromatic rings may be substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above).

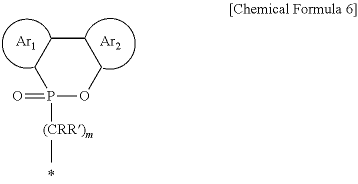

In Chemical Formula 6 shown above, Arₜ and Arₑ may be substituted or unsubstituted C4 to C30 aromatic ring groups, R and R′ may be the same or different, may be hydrogen, a C1 to C20 alkyl group or a C6 to C30 aryl group, and m may be an integer of 0 to 3.

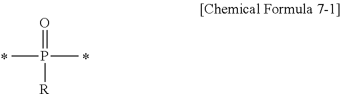

In Chemical Formula 7-1 shown above, R may be hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group.

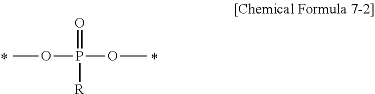

In Chemical Formula 7-2 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group.

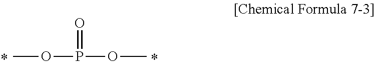

In a different embodiment of the present invention, Chemical Formula 7-3 may not have R.

A number average molecular weight of the liquid crystal oligomer may be 500 to 10,000 g/mol. When the liquid crystal oligomer has the foregoing range of number average molecular weight, it has an appropriate crosslink density.

The structural unit of Chemical Formula 1 may be included in an amount of 5 to 60 mol % of the total amount of the liquid crystal oligomer, and the structural unit of Chemical Formula 2 may be included in an amount of 40 to 95 mol % of the total amount of the liquid crystal oligomer.

When the structural unit of Chemical Formula 1 and the structural unit of Chemical Formula 2 are included within the foregoing range, solubility of the liquid crystal oligomer can be enhanced, the insulating resin composition can be hardened without a crosslinking reaction within the liquid crystal oligomer, and thus, mechanical properties thereof can be enhanced.

L₁ in Chemical Formula 4-7 shown above may be an ether group, a sulfide group, a ketone group, sulfoxide, a sulfone group, an azo group, a cyanide group, a substituted or unsubstituted C1 to C20 alkylene group, a substituted or unsubstituted C2 to C20 alkenyl group, or a substituted or unsubstituted C6 to C30 arylene group. A specific example of L₁ may be any one of those represented by Chemical Formula 9-1 to Chemical Formula 9-10 shown below.

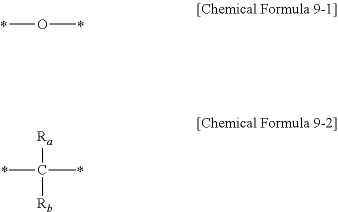

In Chemical Formula 9-2, Rₐ and R_{b} may be hydrogen, halogen, a C1 to C5 alkyl group, a C1 to C5 haloalkyl group, or Z1 (as defined in Chemical Formula 1 shown above), independently.

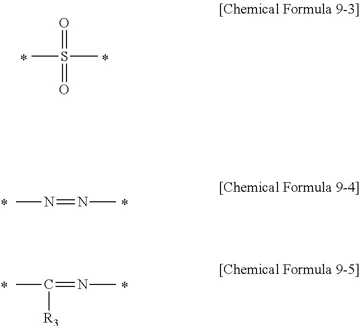

In Chemical Formula 9-5, Rₐ may be hydrogen, halogen, a C1 to C5 alkyl group, a C1 to C5 haloalkyl group, or Z1 (as defined in Chemical Formula 1 shown above), independently.

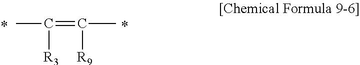

In Chemical Formula 9-6, Rₐ and R_{b} may be hydrogen, halogen, a C1 to C5 alkyl group, a C1 to C5 haloalkyl group, or Z1 (as defined in Chemical Formula 1 shown above), independently.

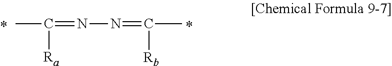

In Chemical Formula 9-7, Rₐ and R_{b} may be hydrogen, halogen, a C1 to C5 alkyl group, a C1 to C5 haloalkyl group, or Z1 (as defined in Chemical Formula 1 shown above), independently.

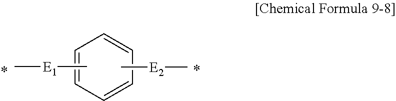

In Chemical Formula 9-8, E₁ and E₂ may be the same or different and may be couplers (or linkers) selected from the group consisting of a single bond, an ether group, an ester group, a ketone group, a sulfide group, sulfoxide, and a sulfone group.

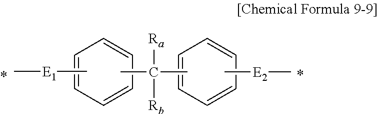

In Chemical Formula 9-9, Rₐ and R_{b} may be hydrogen, halogen, a C1 to C5 alkyl group, a C1 to C5 haloalkyl group, or Z1 (as defined in Chemical Formula 1 shown above), independently, and E₁ and E₂ may be the same or different and may be couplers (or linkers) selected from the group consisting of a single bond, an ether group, an ester group, a ketone group, a sulfide group, sulfoxide, and a sulfone group.

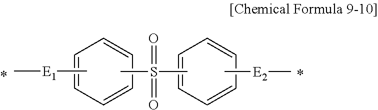

In Chemical Formula 9-10, E₁ and E₂ may be the same or different and may be couplers (or linkers) selected from the group consisting of a single bond, an ether group, an ester group, a ketone group, a sulfide group, sulfoxide, and a sulfone group.

In Chemical Formula 9-8 to Chemical Formula 9-10 shown above, at least one hydrogen atom of the respective aromatic rings may be substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above).

L₂ in Chemical Formula 5-6 may be an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown above, or a bivalent organic functional group of Chemical Formula 7-1 to Chemical Formula 7-3 shown above.

A specific example of L₂ may be any one of those represented by Chemical Formula 9-1 to Chemical Formula 9-10 shown above.

In Chemical Formulas 9-2, 9-5, 9-6, 9-7, and 9-9, Rₐ and R_{b} may be hydrogen, halogen, a C1 to C5 alkyl group, a C1 to C5 haloalkyl group, or Z1 (as defined in Chemical Formula 1 shown above), independently, or a functional group of Chemical Formula 6, and in Chemical Formula 9-8 to Chemical Formula 9-10 shown above, at least one hydrogen atom of the respective aromatic rings may be substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, Z₁ (as defined in Chemical Formula 1 shown above), or the functional group of Chemical Formula 6 shown above.

A specific example of Chemical Formula 6 may be Chemical Formula 11 shown below.

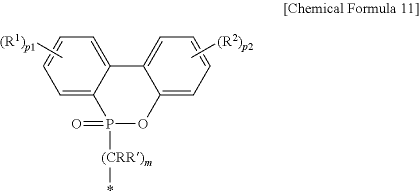

In Chemical Formula 11 shown above, R¹ and R² are the same or different, and are hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above), p1 and p2 are integers of 0 to 4, R and R′ are the same or different, are hydrogen, C1 to C20 alkyl groups, or C6 to C30 aryl groups, and m is an integer of 0 to 3.

In the present embodiment, the liquid crystal oligomer may include a hydroxyl group in one or more of a side chain or an end. Thus, the insulating resin composition may be hardened according to a crosslinking reaction between the liquid crystal oligomer and the epoxy resin, instead of a crosslinking reaction between liquid crystal oligomers.

Also, the liquid crystal oligomer may include a functional group containing phosphorous in a main chain or a side chain thereof, and in this case, flame resistance (or fire retardancy) of the insulating resin composition can be enhanced.

The liquid oligomer according to the present embodiment may be represented by Chemical Formula 12 shown below.

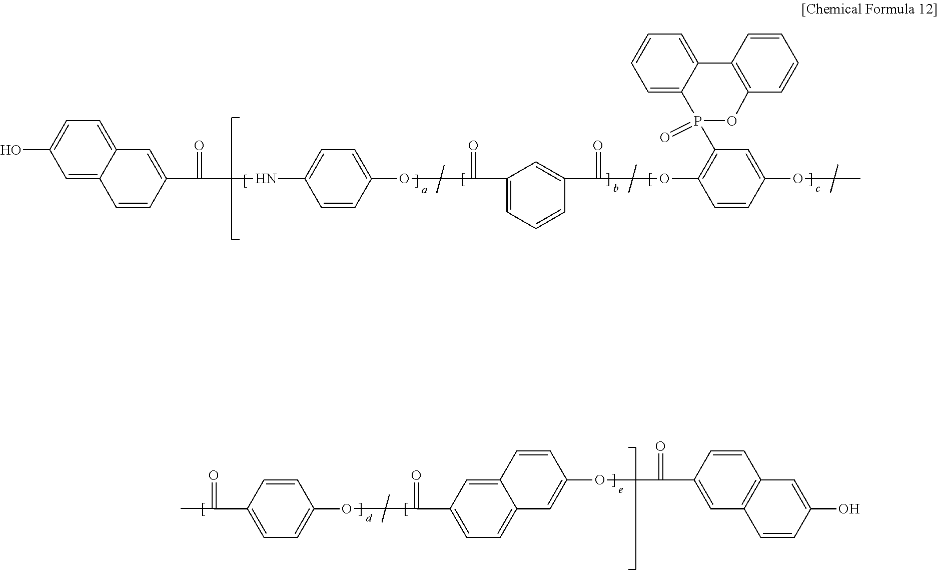

In Chemical Formula 12 shown above, a, b, c, d, and e indicate a mole ratio of a structural unit, which may be determined according to the content of a starting material.

As mentioned above, the structural unit of Chemical Formula 1 may be 5 to 60 mol % of the total amount of the liquid crystal oligomer, and the structural unit of Chemical Formula 2 may be 40 to 95 mol % of the total amount of the liquid crystal oligomer.

In an embodiment of the present invention, the mole ratio of the structural unit of the liquid crystal oligomer is not particularly limited and, preferably, the aforementioned a, b, c, d, and e may be determined within the foregoing range.

The number average molecular weight of the liquid oligomer represented in Chemical Formula 12 shown above may range from 2000 to 5000 g/mol, and a, b, c, d, and e may be determined within the number average molecular weight.

The liquid crystal oligomer represented by Chemical Formula 12 may include a hydroxyl group at both ends thereof and may include a functional group containing phosphorous in a side chain thereof.

According to the present embodiment, solubility can be enhanced by including the liquid crystal oligomer represented by Chemical Formula 12. Also, the insulating resin composition may be hardened according to a crosslinking reaction between the liquid crystal oligomer and the epoxy resin, instead of a crosslinking reaction between liquid crystal oligomers, and thus, mechanical properties thereof can be enhanced.

The liquid crystal oligomer may be included in an amount of 20 to 50 wt % of the resin composition for a thermal radiation board. If the liquid crystal oligomer is included in an amount exceeding 50 wt %, the resin composition may not be hardened processability such that strength may be degraded and drill processability deteriorated in fabricating a board. In addition, a peel strength value is lowered to below 0.5 kgf/cm, adhesive strength between the interfaces of a copper foil and the resin composition is degraded to result in separation of the interfaces. Also, if the liquid crystal oligomer is included in an amount of less than 20 wt %, thermal conductivity is reduced to below 0.35 W/mk, resulting in an effect of enhancing thermal conductivity characteristics not being sufficiently obtained.

(B) Epoxy Resin

A resin composition for a thermal radiation board according to the present embodiment may include an epoxy resin.

The epoxy resin may be, for example, a phenol-based glycidyl ether epoxy resin such as a phenol novolak epoxy resin, a cresol novolak epoxy resin, naphtol-modified novolak epoxy resin, a bisphenol A type epoxy resin, a bisphenol F type epoxy resin, a biphenyl epoxy resin, triphenyl epoxy resin, and the like; a dicyclopentadiene epoxy resin having a dicyclopentadiene frame; a naphthalene epoxy having a naphthalene frame; a dihydroxybenzopyran epoxy resin; a glycidylamine epoxy resin using a polyamine such as diaminophenylmethane, or the like, as a raw material; a triphenolmethane epoxy resin; a tetraphenylethane epoxy resin; or a mixture thereof, but the present invention is not limited thereto.

In detail, the epoxy resin may be N,N,N′,N′-Tetraglycidyl-4,4′-methylenebisbenzenamine, polyglycidyl ether of o-cresol-formaldehyde novolac, or a mixture thereof, and more preferably, the epoxy resin may be N,N,N′,N′-Tetraglycidyl-4,4′-methylenebisbenzenamine.

The content of the epoxy resin may be 10 to 40 wt %. When the content of the epoxy resin is included within the range, adhesive strength of the insulating composition can be enhanced.

(C) Inorganic Filler

The resin composition for a thermal radiation board according to the present embodiment may include an inorganic filler.

The inorganic filler may be, for example, natural silica, fused silica, amorphous silica, hollow silica, aluminum hydroxide, beohmite, magnesium hydroxide, molybdenum oxide, zinc molybdate, zinc borate, zincstannate, aluminum borate, potassium titanate, magnesium sulfate, silicon carbide, zinc oxide, silicon nitride, silicon oxide, aluminum titanate, barium titanate, barium strontium titanate, aluminum oxide, alumina, clay, kaolin, talc, calcinated clay, calcinated kaolin, calcinated talc, mica, and short glass fiber, but the present invention is not limited thereto.

The inorganic filler may be obtained by mixing two or more of a spherical inorganic filler, a flake-type inorganic filler, and a whisker-type inorganic filler.

The inorganic filler may be used alone or two or more inorganic fillers may be mixed to be used. The inorganic filler can lower thermal expansion coefficient of the liquid crystal oligomer and enhance heat dissipation characteristics.

The content of the inorganic filler may be 10 to 40 wt %. If the inorganic filler is included in an amount of less than 10 wt %, thermal conductivity is too low to secure heat dissipation characteristics, and if the inorganic filler is included in an amount exceeding 40 wt %, the content of the resin is relatively low, degrading flow characteristics, and hole processing is too difficult to secure board productability

(D) Hardening Catalyst

The resin composition for a thermal radiation board according to the present embodiment may include a hardening catalyst.

The hardening catalyst may be, for example, 2-methylimidazole, 2-phenylimidazole, 2-phenyl-4-phenyl imidazole, bis(2-ethyl-4-methylimidazole), 2-phenyl-4-methyl-5-hydroxymethylimidazole, 2-phenyl-4,5-dihydroxymethylimidazole, trizine added imidazole, anhydride methyl nadic acid, dicyandiamide, phthalic anhydride, tetrahydrophthalic anhydride, methylbutyltetrahydro phthalic anhydride, hexahydro phthalic anhydride, methylhydrophthalic anhydride, trimethylic acid anhydride, pyromethalic acid anhydride, or benzophenonetetracarboxylic acid anhydride, and the like, and these may be mixed to be used. However, the present invention is not limited thereto.

More preferably, the hardening catalyst may be dicyandiamide.

The content of the hardening catalyst may be 0.2 to 0.4 wt %. If the content of the hardening catalyst is less than 0.2 wt o, a crosslinking reaction is degraded to degrade coefficient of thermal expansion and glass transition temperature characteristics, and when the content of the hardening catalyst exceeds 0.4 wt %, a hardening reaction between epoxy resins, rather than a hardening reaction between the epoxy resin and the liquid crystal oligomer is dominant to degrade mechanical properties and heat resistance.

(E) Solvent

The resin composition for a thermal radiation board according to the present embodiment may further include a solvent.

As the solvent, an aprotic solvent may be used. For example, a halogen-based solvent such as 1-chlorobutane, chlorobenzene, 1,1-dichloroethane, 1,2-dichloroethane, chloroform, and 1,1,2,2-tetrachloroethane, or the like; an ether-based solvent such as dimethylether, tetrahydropurane, 1,4-dioxane, or the like; a ketone-based solvent such as methylethylketone (MEK), acetone, cyclohexanon, or the like; an acetate-based solvent such as propylene glycol monomethyl ether acetate (PGMEA), or the like; an ester-based solvent such as ethyl acetate, or the like; a lactone-based solvent such as γ-butyrolactone, or the like; a carbonate-based solvent such as ethylenecarbonate, propylenecarbonate, or the like; an amine-based solvent such as triethylamine, pyridine, or the like; a nitrile-based solvent such as acetonitrile, or the like; an amide-based solvent such as N,N′ dimethylformamide (DMF), N,N′ dimethylacetamide (DMAc), tetramethylurea, N-methylpyrrolidone (NMP), or the like; a nitro-based solvent such as nitromethane, nitrobenzene, or the like; a sulfide-based solvent such as dimethyl sulfoxide (DMSO), sulforane, or the like; a phosphoric acid-based solvent such as hexamethylphosphoroamidate, tri-n-butylphosphoric acid, or the like; or a combination thereof. However, the present invention is not limited thereto.

(F) Other Additives

The resin composition for a thermal radiation board according to the present embodiment may further include additives such as an organic filler, a softener, a plasticizer, an anti-oxidant, a flame retardant, an auxiliary flame retardant, a lubricant, an antistatic agent, a coloring agent, a thermal stabilizer, a photostabilizer, a UV absorbent, a coupling agent, and an antisetting agent.

The organic filler may be, for example, epoxy resin powder, melamine resin powder, urea resin powder, benzoguanamine resin powder, styrene resin, and the like, but the present invention is not limited thereto.

The plasticizer may be, for example, polyethylene glycol, polyamide oligomer, ethylenebis, stearoamide, phthalic acid ester, polystyrene oligomer, liquid paraffin, polyethylene wax, silicon oil, and the like, but the present invention is not limited thereto. These elements may be used alone or two or more of them may be mixed to be used as necessary.

The anti-oxidant may be, for example, a phosphorous-containing anti-oxidant, phenol-based anti-oxidant, sulfur-containing anti-oxidant, and the like, but the present invention is not limited thereto. These elements may be used alone or two or more of them may be mixed to be used as necessary.

The resin composition for a thermal radiation board according to the present embodiment may be fabricated by blending the foregoing constituent components according to various methods such as room temperature mixing, melt mixing, or the like.

According to another embodiment of the present invention, a thermal radiation board includes: a metal layer; an insulating layer formed on the metal layer; and a circuit pattern formed on the insulating layer, wherein the insulating layer is made of a resin composition including 20 to 50 wt % of a liquid crystal oligomer including the structural unit of Chemical Formula 1 shown below and that of Chemical Formula 2 shown below, and including a functional group of Chemical Formula E shown below in at least one end thereof; 10 to 40 wt % of an epoxy resin; and 10 to 40 wt % of an inorganic filler.

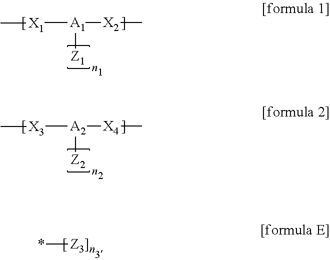

According to an embodiment of the present invention, a sheet-type film includes 20 to 50 wt % of a liquid crystal oligomer including the structural unit of Chemical Formula 1 shown above and that of Chemical Formula 2 shown above, and including a functional group of Chemical Formula E shown above in at least one end thereof; 10 to 40 wt % of an epoxy resin; and 10 to 40 wt % of an inorganic filler.

The resin composition for a thermal radiation board according to an embodiment of the present invention may be applied to an insulating layer of a thermal radiation board, and has excellent heat resistance and thermal conductivity characteristics.

Thus, when the insulating layer is applied between a metal layer and a copper foil layer, an LED package having excellent characteristics can be provided.

### Embodiment 1

13.2 g of liquid crystal oligomer represented by Chemical Formula 12 shown below, 8.8 g of N,N,N′,N′-Tetraglycidyl-4,4′-methylenebisbenzenamine, 33.0 g of silica, and 0.22 g of dicyandiamide were added to 45.0 g of N,N′ dimethylacetamide (DMAc) to prepare a mixed solution. A glass cloth was impregnated with the mixed solution and dried at a temperature of 120° C. so as to be semi-hardened to fabricate a prepreg.

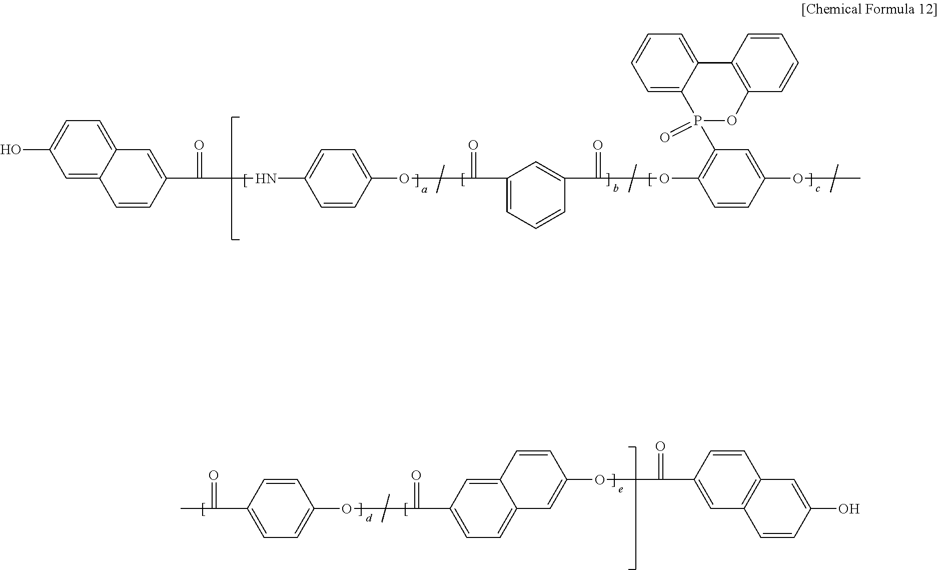

### Embodiment 2

8.8 g of the same liquid crystal oligomer as that of Embodiment 1, 13.2 g of N,N,N′,N′-Tetraglycidyl-4,4′-methylenebisbenzenamine, 33.0 g of silica, and 0.33 g of dicyandiamide were added to 45.0 g of N,N′ dimethylacetamide (DMAc) to prepare a mixed solution. A glass cloth was impregnated with the mixed solution and dried at a temperature of 120° C. so as to be semi-hardened to fabricate a prepreg.

### Comparative Example 1

33.0 g of the same liquid crystal oligomer as that of Embodiment 1, 22.0 g of YDF-170 (an oligomer reaction product of formaldehyde, 1-chloro-2,3-epoxypropane, and phenol of Kukdo Chemical. Co. Ltd.), and 0.22 g of dicyandiamide were added to 45.0 g of N,N′ dimethylacetamide (DMAc) to prepare a mixed solution. A glass cloth was impregnated with the mixed solution and dried at a temperature of 120° C. so as to be semi-hardened to fabricate a prepreg.

[Evaluation]

The prepregs fabricated according to the Embodiments 1 and 2 and the Comparative example were evaluated as follows and the results are shown in Table 1.

1. Evaluation of Thermal Characteristics of Prepregs

The prepregs fabricated according to the Embodiments 1 and 2 and the Comparative example were laminated together with a copper foil at a temperature of 230° C. and thermally set to fabricate a copper foil laminated plate. Thereafter, the copper foil was removed to fabricate a hardened prepreg sample.

A glass transition temperature of the sample was measured by using a dynamic mechanical analyzer (TA Instruments DMA Q800).

Thermal conductivity of the sample was measured at a temperature of 25° C. by using a thermal conductivity measuring instrument NAanoFlash, LFA447, Netzsch).

2. Evaluation of Copper Foil Peel Strength Characteristics of Prepreg

A copper foil having a width of 1 cm was peeled out from the surface of the copper foil laminated plate, and peel strength of the copper foil with respect to the insulating layer was measured by using a tensile strength measuring instrument (90 degree Peel Test, Crosshead speed: 50 mm/min).

TABLE 1

| | | | Comparative |
|---|---|---|---|
| | Embodiment 1 | Embodiment 2 | example 1 |
| Glass transition | 235 | 236 | 190 |
| temperature (° C.) | | | |
| Thermal | 0.42 | 0.40 | 0.32 |
| conductivity (W/mK) | | | |
| Copper foil peel | 0.9 | 1.0 | 0.5 |
| strength (kgf/cm) | | | |

Referring to Table 1, it can be seen that the prepreg fabricated with the resin composition according to the present embodiment had a high glass transition temperature, enhanced thermal conductivity, and excellent copper foil peel strength characteristics.

In comparison, it can be seen that the prepreg according to the comparative example had a lower glass transition temperature, lower thermal conductivity, and lower copper foil peel strength characteristics.

In particular, since the prepreg according to the present embodiment has excellent thermal conductivity, it can be applied to a thermal radiation board.

As set forth above, according to embodiments of the invention, a resin composition for a thermal radiation board having excellent insulating properties, heat resistance, and thermal conductivity characteristics, and a thermal radiation board employing the same can be provided.

While the present invention has been shown and described in connection with the embodiments, it will be apparent to those skilled in the art that modifications and variations can be made without departing from the spirit and scope of the invention as defined by the appended claims.

What is claimed is:

1. A resin composition for a thermal radiation board, the resin composition comprising:
20 wt % to 50 wt % of a liquid crystal oligomer including a structural unit of Chemical Formula 1 shown below and a structural unit of Chemical Formula 2 shown below and including a functional group of Chemical Formula E shown below on least one end thereof;
10 wt % to 40 wt % of an epoxy resin; and
10 wt % to 40 wt % of an inorganic filter. 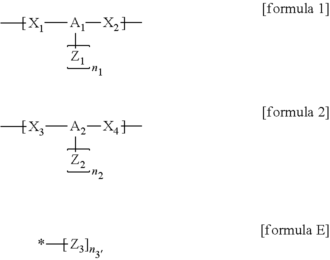
In Chemical Formulas 1 and 2 and Chemical Formula E shown above,
X₁ to X₄ are the same or different and C(═O)O, O, C(═O)NR, NR′, or CO (here, R and R′ are the same or different, are hydrogen, a substituted or unsubstituted C1 to C20 alkyl group, or a substituted or unsubstituted C6 to C30 aryl group),
Z₁ to Z₃ are independently a hydroxyl group, a substituted or unsubstituted C3 to C30 cycloaliphatic group, or a substituted or unsubstituted C3 to C30 heteroatom-containing cycloaliphatic group,
n₁ to n₃ are independently an integer of 0 to 3 and n₁+n₂+n₃ is 1 or greater, and
A₁ in Chemical Formula 1 shown above is one among functional groups represented by Chemical Formula 4-1 to Chemical Formula 4-7 shown below. 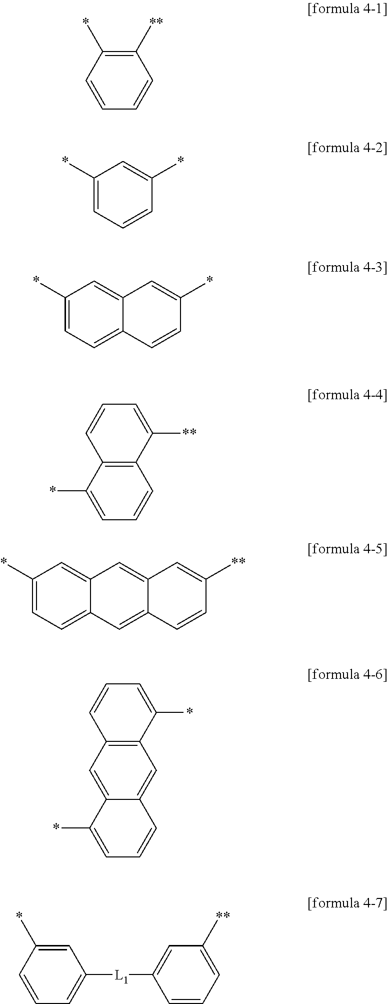
In Chemical Formula 4-7 shown above, L₁ is a bivalent organic functional group, in Chemical Formulas 4-1 to Chemical Formula 4-7 shown above, at least one hydrogen atom of the respective aromatic rings is substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above), and
in Chemical Formula 2 shown above, A₂ is a C2 to C20 alkylene group having one among functional groups represented by Chemical Formula 5-1 to Chemical Formula 5-6 shown below or a functional group of Chemical Formula 6 shown below. 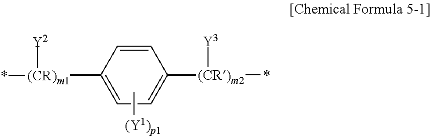
In Chemical Formula 5-1 shown above, Y¹ to Y³ are the same or different, are hydrogen, a C1 to C10 alkyl group, or a functional group of Chemical Formula 6 shown below, and at least one of Y¹ to Y³ is a functional group of Chemical Formula 6 shown below, p1 is an integer of 0 to 4, m1 and m2 are the same or different and are integers of 0.to 3, p1, m1, and m2 are not 0 simultaneously, and R and R′ are hydrogen or a C1 to C10 alkyl group. 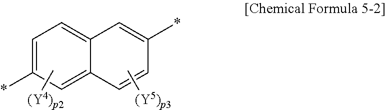
In Chemical Formula 5-2 shown above, Y⁴ and Y⁵ are the same or different, and are hydrogen, a C1 to C10 alkyl group, or a functional group of Chemical Formula 6 shown below, at least one of Y⁴ and Y⁵ is a functional group of Chemical Formula 6 shown below, and p2 and p3 are integers of 0 to 3 and not 0 simultaneously. 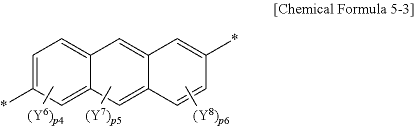
In Chemical Formula 5-3 shown above, Y⁶ to Y⁸ are the same or different, and are hydrogen, a C1 to C10 alkyl group, or a functional group of Chemical Formula 6 shown below, at least one of Y⁶ to Y⁸ is a functional group of Chemical Formula 6 shown below, and p4 to p6 are integers of 0 to 3, p5 is an integer of 0 to 2, and p4, p5, and p6 are not 0 simultaneously. 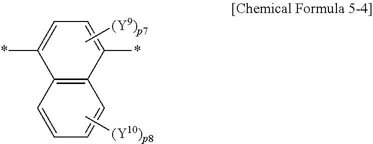
In Chemical Formula 5-4 shown above, Y⁹ and Y¹⁰ are the same or different, and are hydrogen, a C1 to C10 alkyl group, or a functional group of Chemical Formula 6 shown below, at least one of Y⁹ and Y¹⁰ is a functional group of Chemical Formula 6 shown below, and p7 and p8 are integers of 0 to 2 and not 0 simultaneously. 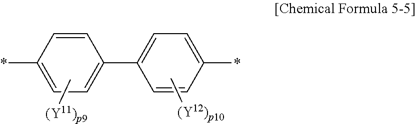
In Chemical Formula 5-5 shown above, Y¹¹ and Y¹² are the same or different, and are hydrogen, a C1 to C10 alkyl group, or a functional group of Chemical Formula 6 shown below, at least one of Y¹¹ and Y¹² is a functional group of Chemical Formula 6 shown below, and p9 and p10 are integers of 0 to 4 and not 0 simultaneously. 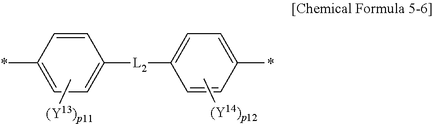
In Chemical Formula 5-6 shown above, Y¹³ and Y¹⁴ are the same or different, and are hydrogen, a C1 to C10 alkyl group, or a functional group of Chemical Formula 6 shown below, at least one of Y¹³ and Y¹⁴ is a functional group of Chemical Formula 6 shown below, and p11 and p12 are integers of 0 to 4, L₂ is an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown below, or a bivalent organic functional group of Chemical Formula 7-1 to Chemical Formula 7-3 shown below, and when L₂ is not substituted with the functional group of Chemical Formula 6 shown below, p11 and p12 are not all 0, and
in Chemical Formula 5-1 to Chemical Formula 5-6 shown above, at least one hydrogen atom of the respective aromatic rings is substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above). 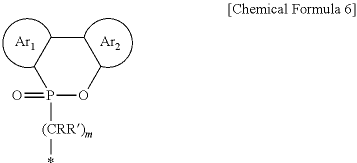
In Chemical Formula 6 shown above, Ar₂ and Arₑ are substituted or unsubstituted C4 to C30 aromatic ring groups, R and R′ are the same or different, are hydrogen, a C1 to C20 alkyl group or a C6 to C30 aryl group, and m is an integer of 0 to 3. 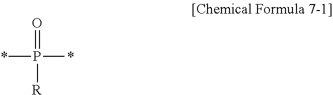
In Chemical Formula 7-1 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group. 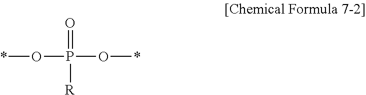
In Chemical Formula 7-2 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group.

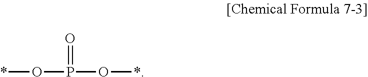

2. The resin composition for a thermal radiation board of claim 1, wherein the epoxy resin is a phenol-based glycidyl ether epoxy resin such as a phenol novolak epoxy resin, a cresol novolak epoxy resin, naphtol-modified novolak epoxy resin, a bisphenol A type epoxy resin, a bisphenol F type epoxy resin, a biphenyl epoxy resin, triphenyl epoxy resin, and the like; a dicyclopentadiene epoxy resin having a dicyclopentadiene frame; a naphthalene epoxy having a naphthalene frame; a dihydroxybenzopyran epoxy resin; a glycidylamine epoxy resin using a polyamine such as diaminophenylmethane, or the like, as a raw material; a triphenolmethane epoxy resin; a tetraphenylethane epoxy resin; or a mixture thereof.

3. The resin composition for a thermal radiation board of claim 1, wherein the epoxy resin is N,N,N′,N′-Tetraglycidyl-4,4′-methylenebisbenzenamine.

4. The resin composition for a thermal radiation board of claim 1, wherein the inorganic filler is one or more of natural silica, fused silica, amorphous silica, hollow silica, aluminum hydroxide, beohmite, magnesium hydroxide, molybdenum oxide, zinc molybdate, zinc borate, zincstannate, aluminum borate, potassium titanate, magnesium sulfate, silicon carbide, zinc oxide, silicon nitride, silicon oxide, aluminum titanate, barium titanate, barium strontium titanate, aluminum oxide, alumina, clay, kaolin, talc, calcinated clay, calcinated kaolin, calcinated talc, mica, and short glass fiber.

5. The resin composition for a thermal radiation board of claim 1, wherein the inorganic filler is obtained by mixing two or more of a spherical inorganic filler, a flake-type inorganic filler, and a whisker-type inorganic filler.

6. The resin composition for a thermal radiation board of claim 1, further comprising 0.2 to 0.4 wt % of the hardening catalyst.

7. The resin composition for a thermal radiation board of claim 1, wherein the hardening catalyst is one or more of 2-methylimidazole, 2-phenylimidazole, 2-phenyl-4-phenyl imidazole, bis(2-ethyl-4-methylimidazole), 2-phenyl-4-methyl-5-hydroxymethylimidazole, 2-phenyl-4,5-dihydroxymethylimidazole, trizine added imidazole, anhydride methyl nadic acid, dicyandiamide, phthalic anhydride, tetrahydrophthalic anhydride, methylbutyltetrahydro phthalic anhydride, hexahydro phthalic anhydride, methylhydrophthalic anhydride, trimethylic acid anhydride, pyromethalic acid anhydride, and benzophenonetetracarboxylic acid anhydride.

8. The resin composition for a thermal radiation board of claim 6, wherein the hardening catalyst is dicyandiamide.

9. The resin composition for a thermal radiation board of claim 1, wherein a number average molecular weight of the liquid crystal oligomer is 500 to 10,000 g/mol.

10. The resin composition for a thermal radiation board of claim 1, wherein L₁ in Chemical Formula 4-7 shown above is an ether group, a sulfide group, a ketone group, sulfoxide, a sulfone group, an azo group, a cyanide group, a substituted or unsubstituted C1 to C20 alkylene group, a substituted or unsubstituted C2 to C20 alkenyl group, or a substituted or unsubstituted C6 to C30 arylene group.

11. The resin composition for a thermal radiation board of claim 1, wherein L₂ in Chemical Formula 5-6 is an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown above, or a bivalent organic functional group of Chemical Formula 7-1 to Chemical Formula 7-3 shown above.

12. The resin composition for a thermal radiation board of claim 1, wherein Chemical Formula 6 is represented by Chemical Formula 11 shown below. 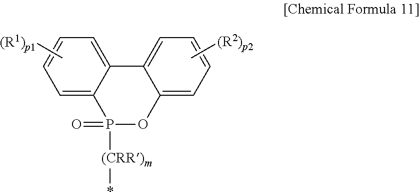
In Chemical Formula 11 shown above, R¹ and R² are the same or different and, are hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above), p1 and p2 are integers of 0 to 4, R and R′ are the same or different, are hydrogen, C1 to C20 alkyl groups, or C6 to C30 aryl groups, and m is an integer of 0 to 3.

13. The resin composition for a thermal radiation board of claim 1, wherein the liquid oligomer is represented by Chemical Formula 12 shown below. 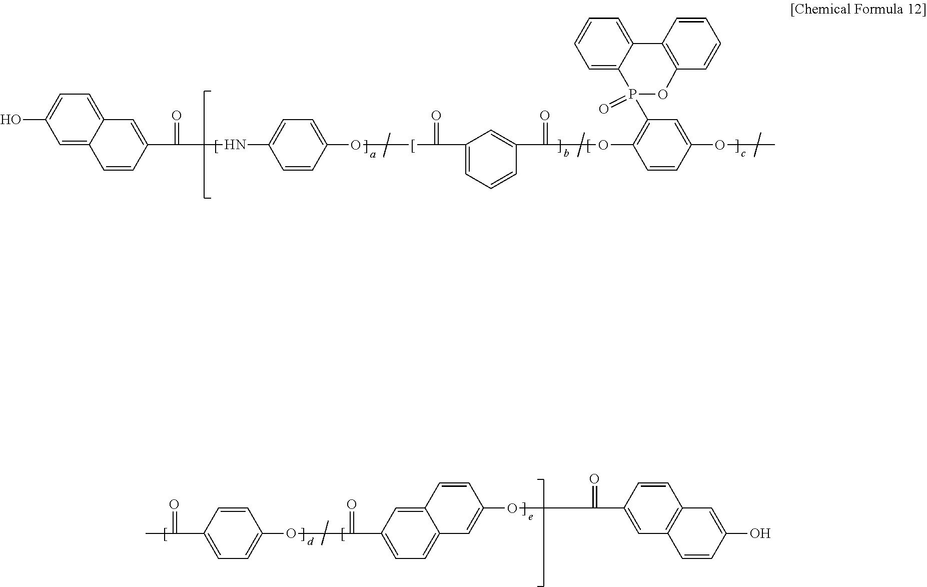
In Chemical Formula 12 shown above, a, b, c, d, and e indicate a mole ratio of a structural unit, which is determined within a number average molecular weight of the liquid oligomer.

14. The resin composition for a thermal radiation board of claim 13, wherein the number average molecular weight of the liquid oligomer represented in Chemical Formula 12 shown above ranges from 2000 to 5000 g/mol.

15. A thermal radiation board comprising:
a metal layer;
an insulating layer formed on the metal layer; and
a circuit pattern formed on the insulating layer,
wherein the insulating layer is made of a resin composition including 20 to 50 wt % of a liquid crystal oligomer including the structural unit of Chemical Formula 1 shown below and that of Chemical Formula 2 shown below, and including a functional group of Chemical Formula E shown below in at least one end thereof; 10 to 40 wt % of an epoxy resin; and 10 to 40 wt % of an inorganic filler.

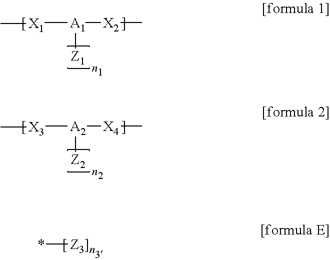

16. A sheet-type film comprising:
20 to 50 wt % of a liquid crystal oligomer including the structural unit of Chemical Formula 1 shown above and that of Chemical Formula 2 shown above, and including a functional group of Chemical Formula E shown above in at least one end thereof;
10 to 40 wt % of an epoxy resin; and
10 to 40 wt % of an inorganic filler. 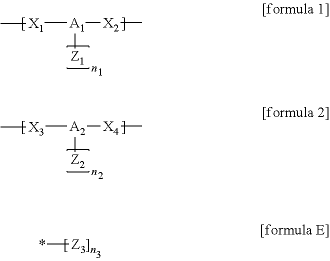
In Chemical Formulas 1 and 2 and Chemical Formula E shown above,
X₁ to X₄ are the same or different and C(═O)O, O, C(═O)NR, NR′, or CO (here, R and R′ are the same or different, are hydrogen, a substituted or unsubstituted C1 to C20 alkyl group, or a substituted or unsubstituted C6 to C30 aryl group),
Z₁ to Z₃ are independently a hydroxyl group, a substituted or unsubstituted C3 to C30 cycloaliphatic group, or a substituted or unsubstituted C3 to C30 heteroatom-containing cycloaliphatic group,
n₁ to n₃ are independently an integer of 0 to 3 and n₁+n₂+n₃ is 1 or greater, and
A₁ in Chemical Formula 1 shown above is one among functional groups represented by Chemical Formula 4-1 to Chemical Formula 4-7 shown below. 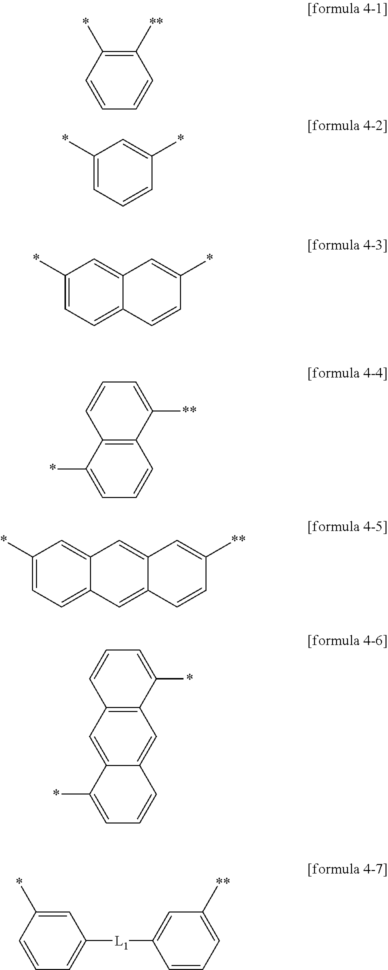
In Chemical Formula 4-7 shown above, L₁ is a bivalent organic functional group, in Chemical Formulas 4-1 to Chemical Formula 4-7 shown above, at least one hydrogen atom of the respective aromatic rings is substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above), and
in Chemical Formula 2 shown above, A₂ is a C2 to C20 alkylene group having one among functional groups represented by Chemical Formula 5-1 to Chemical Formula 5-6 shown below or a functional group of Chemical Formula 6 shown below. 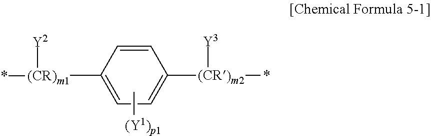
In Chemical Formula 5-1 shown above, Y¹ to Y³ are the same or different, are hydrogen, a C1 to C10 alkyl group, or a functional group of Chemical Formula 6 shown below, and at least one of Y¹ to Y³ is a functional group of Chemical Formula 6 shown below, p1 is an integer of 0 to 4, m1 and m2 are the same or different and are integers of 0. to 3, p1, m1, and m2 are not 0 simultaneously, and R and R′ are hydrogen or a C1 to C10 alkyl group. 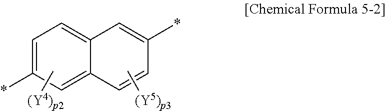
In Chemical Formula 5-2 shown above, Y⁴ and Y⁵ are the same or different, and are hydrogen, a C1 to C10 alkyl group, or a functional group of Chemical Formula 6 shown below, at least one of Y⁴ and Y⁵ is a functional group of Chemical Formula 6 shown below, and p2 and p3 are integers of 0 to 3 and not 0 simultaneously. 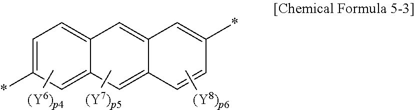
In Chemical Formula 5-3 shown above, Y⁶ to Y⁸ are the same or different, and are hydrogen, a C1 to C10 alkyl group, or a functional group of Chemical Formula 6 shown below, at least one of Y⁶ to Y⁸ is a functional group of Chemical Formula 6 shown below, and p4 to p6 are integers of 0 to 3, p5 is an integer of 0 to 2, and p4, p5, and p6 are not 0 simultaneously. 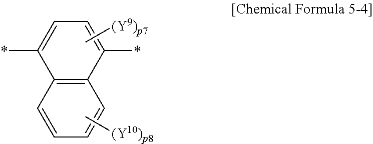
In Chemical Formula 5-4 shown above, Y⁹ and Y¹⁰ are the same or different, and are hydrogen, a C1 to C10 alkyl group, or a functional group of Chemical Formula 6 shown below, at least one of Y⁹ and Y¹⁰ is a functional group of Chemical Formula 6 shown below, and p7 and p8 are integers of 0 to 2 and not 0 simultaneously. 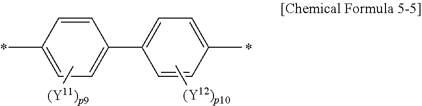
In Chemical Formula 5-5 shown above, Y¹¹ and Y′2 are the same or different, and are hydrogen, a C1 to C10 alkyl group, or a functional group of Chemical Formula 6 shown below, at least one of Y¹¹ and Y¹² is a functional group of Chemical Formula 6 shown below, and p9 and p10 are integers of 0 to 4 and not 0 simultaneously. 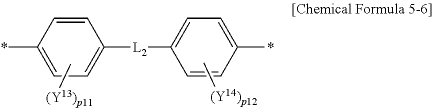
In Chemical Formula 5-6 shown above, Y¹³ and Y¹⁴ are the same or different, and are hydrogen, a C1 to C10 alkyl group, or a functional group of Chemical Formula 6 shown below, at least one of Y¹³ and Y¹⁴ is a functional group of Chemical Formula 6 shown below, and p11 and p12 are integers of 0 to 4, L₂ is an ether group, a sulfide group, a ketone group, an amide group, sulfoxide, a sulfone group, an azo group, a cyanide group, a substituted or unsubstituted C1 to C20 alkylene group, a substituted or unsubstituted C2 to C20 alkenyl group, a substituted or unsubstituted C6 to C30 arylene group, a bivalent organic functional group substituted or unsubstituted with at least one functional group of Chemical Formula 6 shown below, or a bivalent organic functional group of Chemical Formula 7-1 to Chemical Formula 7-3 shown below, and when L₂ is not substituted with the functional group of Chemical Formula 6 shown below, p11 and p12 are not all 0, and
in Chemical Formula 5-1 to Chemical Formula 5-6 shown above, at least one hydrogen atom of the respective aromatic rings is substituted with halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group, or Z₁ (as defined in Chemical Formula 1 shown above). 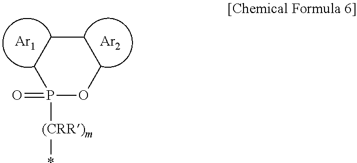
In Chemical Formula 6 shown above, Ar₁ and Ar₂ are substituted or unsubstituted C4 to C30 aromatic ring groups, R and R′ are the same or different, are hydrogen, a C1 to C20 alkyl group or a C6 to C30 aryl group, and m is an integer of 0 to 3. 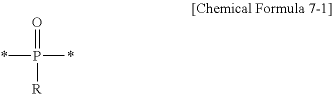
In Chemical Formula 7-1 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group. 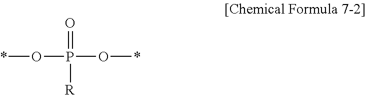
In Chemical Formula 7-2 shown above, R is hydrogen, halogen, a substituted or unsubstituted C1 to C20 alkyl group, a substituted or unsubstituted C1 to C20 alcoxy group, a substituted or unsubstituted C3 to C20 cycloalkyl group, a substituted or unsubstituted C6 to C30 aryl group, a substituted or unsubstituted C7 to C30 arylalkyl group, a substituted or unsubstituted C6 to C30 aryloxy group. [chemical structure]
